(19) United States
(12) Patent Application Publication
(10) Pub. No.: US 2017/0358013 A1
(43) Pub. Date: Dec. 14, 2017

(54) SYSTEMS FOR DYNAMICALLY ADJUSTING ONLINE MARKETING CAMPAIGNS AND RELATED METHODS

(71) Applicant: Viesoft, Inc., San Francisco, CA (US)

(72) Inventor: Anthony Vierra, San Francisco, CA (US)

(21) Appl. No.: 15/178,226

(22) Filed: Jun. 9, 2016

(51) Int. Cl. G06Q 30/02; G06F 17/30

(52) U.S. Cl. CPC G06Q 30/0277; G06Q 30/0275; G06Q 30/0244; G06F 17/30867

(57) ABSTRACT

A system and method for dynamically adjusting an online marketing campaign, in various embodiments, is configured to increase and/or decrease one or more keyword bids that make up part of an online mark'seting campaign for a particular product from a particular retailer based on whether: (1) the particular product is or is not competitively priced relative to one or more competing retailers; and/or (2) an advertisement for the particular product from the particular retailer on a search engine results page or in an online marketplace is in a relatively desirable position.

### BACKGROUND

Online retailers typically desire to maximize the effectiveness of their online marketing campaigns while minimizing the cost of undertaking such campaigns. Online retailers may further desire to increase conversion of those marketing campaigns into sales. Accordingly, there is currently a need for improved systems for increasing sales derived from online marketing campaigns while reducing cost.

### SUMMARY

A computer-implemented method for dynamically adjusting one or more keyword bids for an online marketing campaign for a first product offered for sale by a first advertiser, according to particular embodiments, comprises: the method comprising: (1) receiving, by one or more processors, first pricing data associated with the first product offered for sale by the first advertiser; (2) receiving, by one or more processors, online marketing campaign data for the first product, the online marketing campaign data comprising: (a) a first keyword associated with the online marketing campaign; and (b) a first bid associated with the first keyword; (3) determining, by one or more processors based at least in part on the first keyword, a position of an advertisement for the first product relative to one or more other advertisements for the first product associated with one or more competing advertisers; (4) determining, by one or more processors, second pricing data associated with the one or more other advertisements; and (5) substantially automatically adjusting the first bid, by one or more processors, based at least in part on the first pricing data, the second pricing data, and the position of the advertisement for the first product relative to the one or more other advertisements.

A computer-implemented method of automatically adjusting an online marketing campaign for a particular product, in various embodiments, comprises: (1) providing a user interface for inputting one or more business rules associated with an online marketing campaign associated with the particular product on a computing device associated with a first retailer; and (2) receiving one or more business rules associated with the online marketing campaign at a marketing campaign server via the user interface over the Internet, the online marketing campaign server comprising one or more processors and a memory that stores online marketing campaign data and pricing data associated with the particular product. In various embodiments: (1) the online marketing campaign data comprises one or more keywords and one or more bids associated with each of the one or more keywords; and (2) the pricing data comprises a price at which the particular product is offered for sale by the first retailer. In still other embodiments, the method further comprises: (1) determining, by one or more processors, a position of a first advertisement for the particular product on a search engine results page derived from an Internet search comprising the one or more keywords; (2) determining, by one or more processors, second pricing data for a second advertisement for the particular product on the search engine results page; and (3) substantially automatically adjusting the one or more bids based at least in part on the position of the first advertisement, the pricing data, the second pricing data, and the one or more business rules.

A computer system for adjusting a marketing campaign for a first product based at least in part on one or more marketing adjustment preferences, in particular embodiments, comprises an online marketing campaign server comprising one or more processors and a memory that stores the one or more marketing adjustment preferences. In various embodiments, the one or more processors are configured for: (1) providing, on a computing device associated with a first retailer, a user interface for providing the one or more marketing adjustment preferences; (2) receiving, via the user interface, the one or more marketing adjustment preferences, wherein the one or more marketing adjustment preferences comprise a request to take a particular action based at least in part on a position and a price of a first advertisement for the first product offered by the retailer relative to one or more second advertisements for the first product offered by one or more second retailers on a search engine results page; (3) storing the one or more marketing adjustment preferences in memory; (4) receiving, via a third party keyword bidding server, marketing campaign data associated with the first product for an online marketing campaign initiated by the first retailer the marketing campaign data comprising a first keyword and a first bid associated with the keyword; (5) submitting a search engine query comprising the keyword, via the Internet, to a search engine associated with the online marketing campaign; (6) in response to submitting the search engine query, receiving a search engine results page; (7) determining a relative position of the first advertisement for the first product from the first retailer with respect to the one or more second advertisements for the first product from the one or more second retailers on the search engine results page; (8) determining a relative price of the first product from the first retailer versus the one or more second retailers; (9) determining, based at least part on the one or more marketing adjustment preferences, whether to adjust the first bid based at least in part on the relative position of the first advertisement with respect to the one or more second advertisements, and the relative price of the first product from the first retailer versus the one or more second retailers; and (10) in response to determining to adjust the first bid, transmitting a request to the third party keyword bidding server to adjust the first bid based at least in part on the one or more marketing adjustment preferences.

### BRIEF DESCRIPTION OF THE DRAWINGS

Various embodiments of a system and method for adjusting an online marketing campaign are described below. In the course of this description, reference will be made to the accompanying drawings, which are not necessarily drawn to scale, and wherein:

FIG. 1 is a block diagram of One or More Marketing Campaign Servers in accordance with an embodiment of the present system;

FIG. 2 is a schematic diagram of a computer, such as the One or More Marketing Campaign Servers of FIG. 1, that is suitable for use in various embodiments;

FIG. 3 depicts a flow chart that generally illustrates various steps executed by a product matching module that, for example, may be executed by the One or More Marketing Campaign Servers of FIG. 1; and

FIG. 4 depicts a screen capture of an exemplary search engine results page that comprises both organic search results and paid search results (e.g., one or more pay-per-click advertisements).

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, a system for dynamically adjusting an online marketing campaign may be configured for adjusting a retailer's online marketing campaign based on, for example, a price adjustment for a particular product by one or more competitors, a competitiveness of a price point of a particular product offered for sale by the retailer compared to one or more competitors, or any other suitable factor. In various embodiments, the adjustment to the online marketing campaign may include, for example, ceasing the online marketing campaign, initiating a new online marketing campaign, adjusting one or more bids for one or more keywords in a keyword bidding advertising system (e.g., Google AdWords, Bing Ads, etc.), or taking any other suitable action.

In various embodiments, the online marketing campaign may include pay-per-click marketing. The pay-per-click marketing, as part of the online marketing campaign, may include one or more bids for one or more keywords through suitable keyword bidding advertising system. For example, a particular nutritional supplement company may bid on keywords relating health promotion, particular products, particular supplements, etc. as part of an online marketing campaign. The company may, for example, provide different bids for different keywords. In various embodiments, the online marketing campaign may be directed toward ensuring that a particular link (e.g., a link to purchase a particular product or products offered for sale by the company) is part of a search engine results page (e.g., to provide exposure to the particular product or products to users of a search engine that have searched for the particular related keywords on which the company has bid). In particular embodiments, the search engine results page may include any suitable search engine results page of a multi-page list of search results (e.g., page 1, page 2, etc.). In various embodiments, a bid price is the price paid by a particular retailer when a user of an Internet search engine clicks on a link associated with the particular retailer on a search engine results page after the user has search for the keyword for which the particular retailer has placed the bid.

In a particular embodiment, the system for dynamically adjusting an online marketing campaign may be configured for: (1) receiving first pricing data for a particular product offered for sale by a first retailer; (2) receive data associated an online marketing campaign for the particular product initiated by the first retailer; (3) determining a position of a first advertisement for the first product from the first retailer in a search engine results page or online shopping marketplace; (4) determining second pricing data for the particular product offered for sale by one or more competing retailers within the search engine results page or online shopping marketplace; and (5) adjusting the online marketing campaign based at least in part on the position of the first advertisement, the first pricing data, and the second pricing data.

For example, a first retailer may reduce a bid on a particular keyword where the first retailer is listed as the first result on a search engine results page associated with the particular keyword. The first retailer may reduce the bid on the particular keyword, for example, because a competing retailer that is the second or third result on the search engine results page associated with the particular keyword is offering the particular product at a lower price than the first retailer. In such an example, the first retailer may be overbidding on the particular keyword because, although users of a search engine searching for the particular keyword are visiting the first retailer's web site, the users are generally completing a purchase for the particular product through the competing retailer's website at the lower price.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

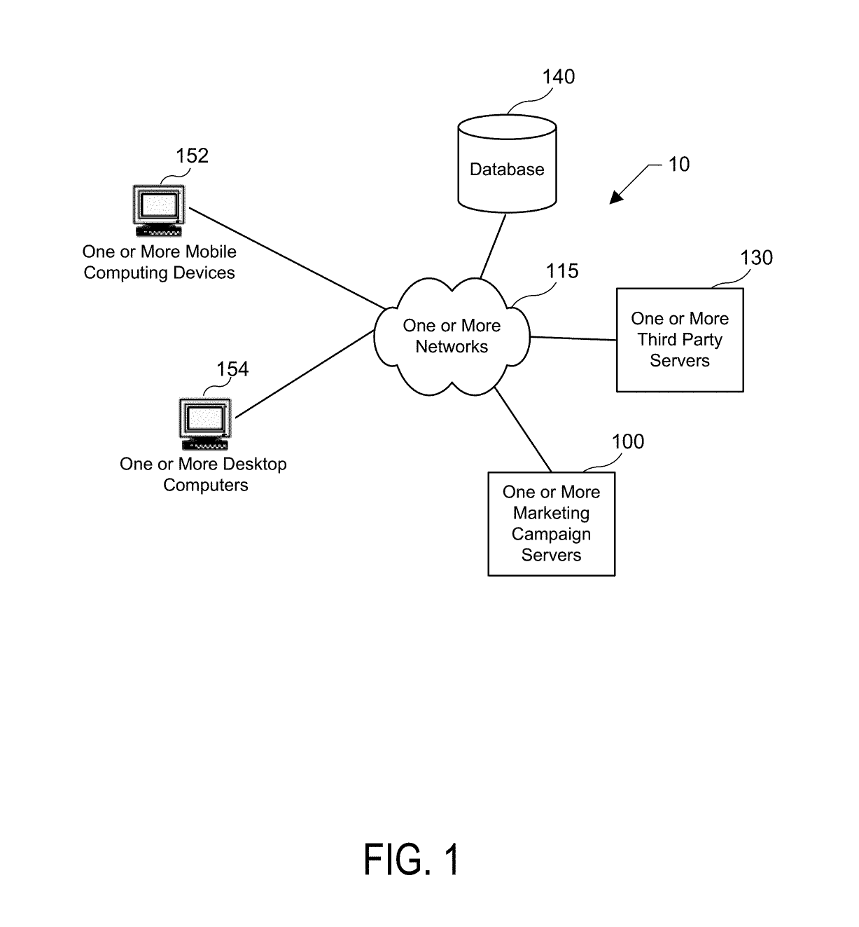

FIG. 1 is a block diagram of a System 110 according to a particular embodiment. As may be understood from this figure, the System 110 includes one or more computer networks 115, a One or More Marketing Campaign Servers 100, One or More Third Party Servers 130, a Database 140, and one or more remote computing devices such as a mobile computing device 152 (e.g., such as a smart phone, a tablet computer, a wearable computing device, a laptop computer, etc.) or a desktop computer 154 (e.g., one or more desktop computers). In particular embodiments, the one or more computer networks facilitate communication between the One or More Marketing Campaign Servers 100, One or More Third Party Servers 130 (e.g., such as a third party keyword bidding server), the Database 140, and the one or more remote computing devices 152, 154.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between One or More Marketing Campaign Servers 100 and Database 140 may be, for example, implemented via a Local Area Network (LAN) or via the Internet.

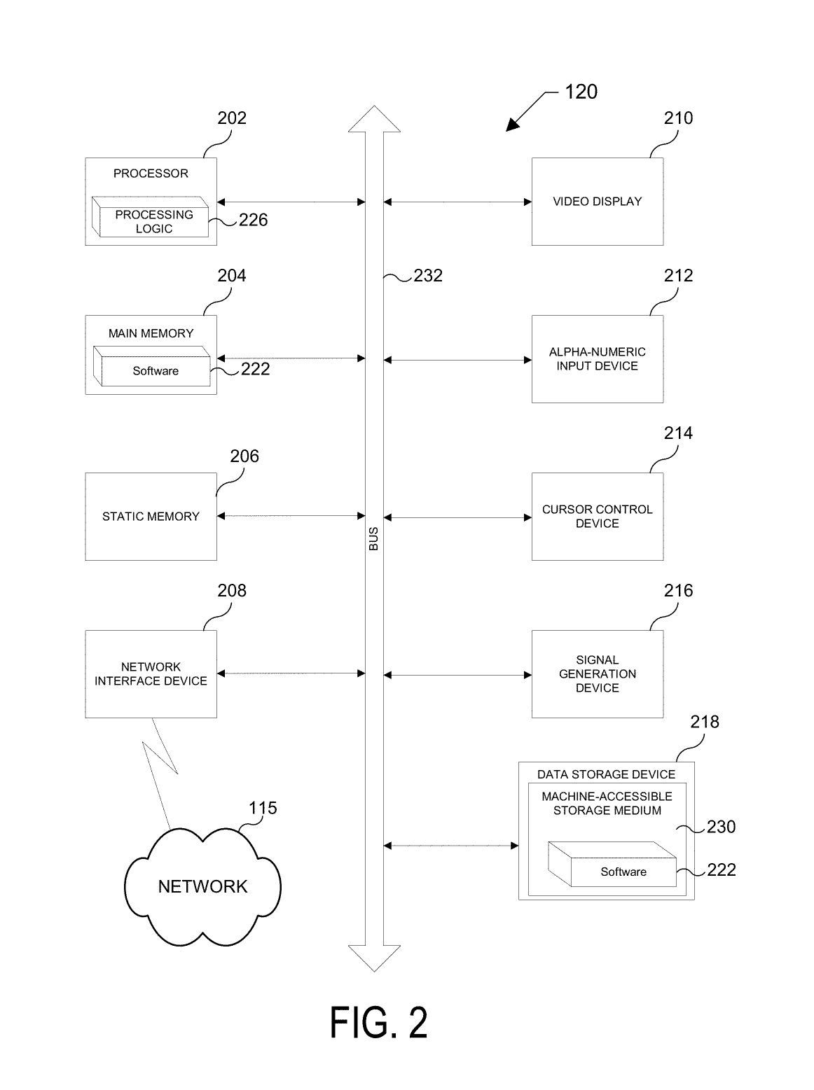

FIG. 2 illustrates a diagrammatic representation of a computer 120 that can be used within the System 110, for example, as a client computer (e.g., one of the remote computing devices 152, 154 shown in FIG. 1), or as a server computer (e.g., One or More Marketing Campaign Servers 100 shown in FIG. 1). In particular embodiments, the computer 120 may be suitable for use as a computer within the context of the System 110 that is configured for adjusting marketing campaigns based on marketing, pricing, and other data.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium (e.g., non-transitory medium) that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

As noted above, systems, according to various embodiments, are adapted to track pricing information and online marketing campaign data in the context of an electronic commerce environment such as the Internet, or other suitable environment. The system may be configured to use this pricing information and online marketing campaign data in any suitable way (e.g., the system may be configured to adjust one or more online marketing campaigns based at least in part on the pricing information and online marketing campaign data.) Various aspects of the system's functionality may be executed by certain system modules, including a Marketing Campaign Adjustment Module 300. This module is discussed in greater detail below.

Marketing Campaign Adjustment Module

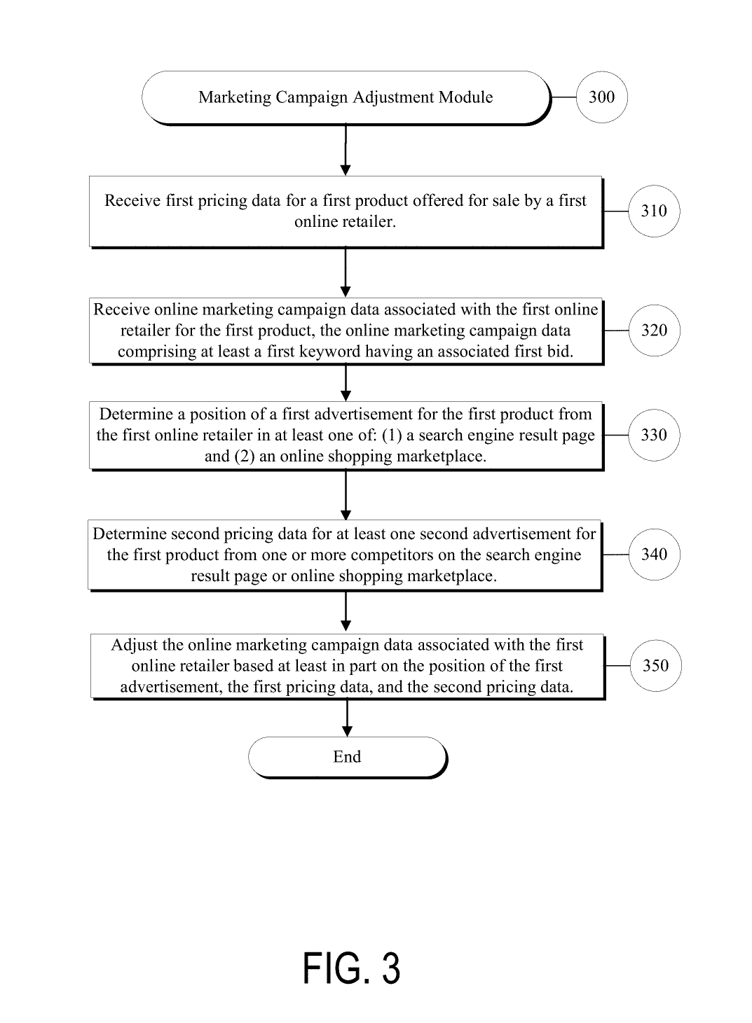

FIG. 3 is a flow chart of operations performed by an exemplary Marketing Campaign Adjustment Module 300, which may, for example, run on the One or More Marketing Campaign Servers 100, or any suitable computing device (such as a suitable mobile computing device). In particular embodiments, the Marketing Campaign Adjustment Module 300 may facilitate an adjustment of one or more bids for one or more keywords in an online marketing campaign based on pricing data and a position of a particular advertisement on a search engine results, an online marketplace, or any other suitable location. In various embodiments, the system is configured to enable a particular retailer to provide one or more business rules (e.g., one or more marketing campaign business rules, one or more marketing campaign adjustment preferences, etc.) upon which the system may facilitate such an adjustment (e.g., a business rule to reduce one or more bids unless the particular retailer is offering a particular product at a price lower than one or more competitors). In various embodiments, the one or more business rules comprise one or more marketing campaign adjustment preferences.

When executing the Marketing Campaign Adjustment Module 300, the system begins, at Step 310, by retrieving first pricing data for a first product offered for sale by a first online retailer. In various embodiments, the system is configured to retrieve the first pricing data from one or more databases (e.g., one or more databases stored in memory) associated with the first online retailer. For example, the system may be configured to retrieve pricing data associated with a first product from the first online retailer substantially automatically. In other embodiments, the system is configured to receive the first pricing data in any other suitable manner (e.g., querying a database of pricing data, receiving input of the first pricing data from a user of the system, etc.).

In particular embodiments, the pricing data comprises a price of the first product (e.g., a price at which the first product is offered for sale from the first online retailer), as well as other suitable information about the first product such as, for example: (1) the product's formal name and any equivalents or abbreviations of that name; (2) other alphanumeric product identification information that may be used to identify the product (e.g., the product's make, model, SKU, etc. . . . ); (3) one or more symbols that may be used to identify the product (e.g., one or more logos associated with the product or the product's source); (4) one or more images of the product; (5) a description of the product (e.g., such as features of the product); (6) product model information; and/or (7) any other suitable information that may be used to identify the product.

Continuing at Step 320, the system is configured to receive online marketing campaign data associated with the first online retailer for the first product. In various embodiments, the online marketing campaign data comprises any suitable data related to one or more online marketing campaigns associated with the first product that are currently being run by the first online retailer. In particular embodiments, the system is configured to receive the online marketing campaign data in response to transmitting a request (e.g., over the Internet) to a third party keyword bidding server (e.g., a third party keyword bidding server associated with a keyword advertising service such as Google Adwords through which the first online retailer has initiated an online marketing campaign).

In various embodiments, the online marketing campaign data comprises data associated with a keyword-bidding advertising system. In such embodiments, the online marketing data comprises at least one first keyword associated with the online marketing campaign and a first bid associated with the at least one first keyword. In various embodiments, the at least one keyword includes at least one keyword that is related to the particular product. For example, if the particular product is a particular model of television (e.g., a 55 inch Samsung 4k LED television), the online marketing campaign may include at least one keyword that includes ‘Samsung’, ‘LED’, ‘55 inch’, or any other suitable keyword which the first online retailer may desire to include in the online marketing campaign (e.g., any suitable keyword that the first online retailer believes a person who may be interested in purchasing a 55 inch Samsung 4k LED television might search for using an Internet search engine). In various embodiments, a particular keyword may comprise a plurality of words; a combination of words, a single word, a phrase, or any other suitable combination of alphanumeric or other characters. In various embodiments, a particular retailer may have a plurality of online marketing campaigns for a plurality of different products.

As may be understood by one skilled in the art, a particular bid on a particular keyword by a retailer may, for example, influence (along with one or more additional factors) a position in which an advertisement for a particular product offered for sale by the retailer may appear in a search engine results page associated with the particular keyword (e.g., on a search engine results page resulting from a search that includes the particular keyword) or in an online shopping marketplace. In various embodiments, the online marketing campaign data may include a first bid associated with the at least one first keyword. In still other embodiments, the online marketing campaign data may include a bid for each particular keyword that makes up the online marketing campaign (e.g., an online marketing campaign for a particular product may include a plurality of keywords, each having an associated bid). In still other embodiments, the online marketing campaign data may include a maximum bid associated with each particular keyword. In still other embodiments, the online marketing campaign data may include a bid range for each particular keyword. In various embodiments, each bid may include a particular price the retailer is willing to pay for each incidence of a user clicking a link to the retailer's advertised product following a search on the search engine, by the user that includes the associated keyword.

Returning to Step 330, the system continues by determining a position of a first advertisement for the first product from the first online retailer in at least one of: (1) a search engine results page; and (2) an online marketplace. The system may, for example, determine the position of a first advertisement for the first product from the first online retailer in a search engine results page by: (1) running a search (e.g., a simulated search) using a particular search that comprises at least one keyword that makes up part of the online marketing campaign; and (2) determining, based at least in part on a resulting search engine results page, a position of the first advertisement for the first product from the first online retailer within the search engine results page (e.g., relative to one or more other advertisements for the first product on the search engine results page).

In particular embodiments, a simulated search may generate a search engine results page that is substantially similar (e.g., the same as) a search engine results page that a user of the search engine would see in response to performing a search for a particular word or combination of words. In various embodiments, the system is configured to simulate one or more searches that include each particular keyword that make up the online marketing campaign. In still other embodiments, the system may determine one or more actual search results resulting from an Internet search via one or more particular search engines. In still other embodiments, the system is configured to simulate one or more searches that include one or more combinations of keywords associated with the online marketing campaign. In various other embodiments, the system is configured to simulate one or more searches for every possible combination of keywords that make up the online marketing campaign.

As may be understood by one skilled in the art, a position of an advertisement for a particular product from a particular retailer may vary based at least in part on which particular keyword or combination of keywords for which the system performed a simulated search. For example, a particular advertisement from Amazon.com for the 55 inch 4k Samsung television described above may appear first on a search engine results page following a search for the term “55 inch Samsung television” but may appear third in a listing of search engine results page following a search for the term “55 inch television.” In various embodiments, the system is configured to determine a position of the first advertisement for each particular keyword that makes up the online marketing campaign. In various other embodiments, the system is configured to determine the position of the first advertisement for one or more combinations of the one or more keywords that make up the online marketing campaign. In still other embodiments, the system is configured to determine the position of the first advertisement for every possible combination of keywords that make up the online marketing campaign.

For example, for an online marketing campaign for a particular product that includes a bid for a first keyword, a second keyword, and a third keyword, the system may be configured to determine a position of an advertisement for the particular product from the particular retailer on a search engine results page resulting from a search for: (1) just the first keyword; (2) just the second keyword; (3) just the third keyword; (4) the first keyword and the second keyword; (5) the first keyword and the third keyword; (6) the second keyword and the third keyword; and (7) the first keyword, the second keyword, and the third keyword.

As may be understood by one skilled in the art, the position of the first advertisement may vary over time (e.g., even if a bid for a particular keyword remains the same) for various reasons. For example, the position of the first advertisement may vary due to: (1) one or more changes in one or more keyword bids by one or more other advertisers; (2) one or more changes in other factors that may influence a position of the first advertisement (e.g., quality score, retailer website traffic, click through rate, etc.). Accordingly, in various embodiments, the system is configured to determine the position of the first advertisement substantially regularly (e.g., on a regular basis). For example, in various embodiments, the system is configured to determine the position: (1) every day; (2) every hour; (3) every minute; and/or (4) any other suitable time period. In other embodiments, the system is configured to determine the position substantially continuously (e.g., continuously).

In various other embodiments, the system is configured to determine the position with a frequency determined by an amount of computing resources (e.g., processing power, network bandwidth, etc.) assigned to the task of determining the position. In various embodiments, the system may be configured to enable a retailer to assign particular computing resources on a product-by-product, keyword-by-keyword, or any other suitable basis. In such embodiments, the system may enable the retailer to dedicate greater computing resources to products or keywords which may, for example, be more competitive (e.g., which may have a greater number of retailers bidding on particular keywords or particular keywords associated with the particular product) such that the position of the first advertisement for the particular product may vary more frequently.

Although the position of the first advertisement above is described generally with respect to being listed first, second, third, etc. within a search engine results page, it should be understood that, in various embodiments, a search engine results page may generally have portions of the search engine results page that are more or less desirable for the placement of advertisements. For example, in various embodiments, a search engine results page may include one or more advertisements adjacent an upper portion of the search engine results page. In other embodiments, the search engine results page may further include one or more advertisements adjacent a left portion, right portion, central portion, or lower portion of the search engine results page. In still other embodiments, various of the one or more advertisements within a particular search engine results page may vary in size (e.g., some may be larger in size and others may be smaller). In some embodiments, some of the one or more advertisements on the search engine results page may be in color while others are in black and white. In various embodiments, one or more advertisements may include one or more images (e.g., video images or still images), may include bolded or underlined text, etc.

As may be appreciated by one skilled in the art, an amount of screen space dedicated to a particular advertisement as well as one or more additional factors such as: (1) position; (2) color; (3) font; (4) font size; (5) contrast; (6) inclusion of images; (7) listing of price within the advertisement; (8) etc. may affect a desirability of a particular advertisement within a search engine results page (e.g., relative to one or more other advertisements on the search engine results page). For example, consider a search engine results page having: (1) a first advertisement disposed adjacent a top portion of the search engine results page containing bolded text in a large size font; and (2) a second advertisement disposed adjacent a lower right portion of a search engine results page in a small, non-bolded font. In this example, the first advertisement is likely more desirable from an advertiser perspective, for example, because the first advertisement would likely appear more prominent to a user viewing the search engine results page (e.g., and may, in turn, be more likely to be clicked by the user).

Returning to Step 340, the system continues by determining second pricing data for at least one second advertisement for the first product from one or more competing retailers on the search engine results page or online marketplace. The system may, in various embodiments, determine pricing data for each advertisement for the particular product on the search engine results page. In other embodiments, the system may determine a position of each advertisement on the search engine results page in addition to a price of the particular product in each advertisement. In various embodiments, the system is configured to determine the second pricing data from the at least one second advertisement itself. In other embodiments, the system is configured to access a landing page associated with the at least one second advertisement and determine the pricing data from the landing page.

In particular embodiments, the system is further configured to determine a position of the at least one second advertisement (e.g., on the search engine results page). In other embodiments, the system is configured to determine the position of the at least one second advertisement relative to the first advertisement (e.g., to determine which advertisement is in a more desirable position on the search engine results page such as a higher position, more prominent position such as the top of the page versus the side of the page or the left side of the page versus the right side, etc.). In still other embodiments, the system is configured to compare a size, layout, color profile, font size, etc. of the first advertisement with the at least one second advertisement.

Continuing to Step 350, the system adjusts the online marketing campaign based at least in part on the position of the first advertisement, the first pricing data, and the second pricing data. In particular embodiments, adjusting the online marketing campaign may include for example: (1) adjusting (e.g., increasing or decreasing) the one or more bids on the one or more keywords; (2) ceasing the one or more bids on at least one of the one or more keywords; (3) creating one or more additional bids on one or more new keywords; and/or (4) taking any other suitable action.

In various embodiments, the system is configured to: (1) determine whether to adjust the online marketing campaign based at least in part on the one or more business rules; and (2) in response to determining to adjust the online marketing campaign, adjusting the online marketing campaign based at least in part on the position of the first advertisement, the first pricing data, and the second pricing data. In particular embodiments, the system is configured to adjust the online marketing campaign by, for example, transmitting a request to adjust the one or more bids to a third party keyword-bidding server. In other embodiments, the system is configured to adjust the online marketing campaign by transmitting a request to adjust one or more parameters relating to the marketing campaign to a particular online marketplace.

In various embodiments, the system further adjusts the online marketing campaign based at least in part on the one or more business rules provided by the retailer (e.g., or a user on behalf of the retailer). In particular embodiments, the system is configured to provide a user interface on a computing device associated with the first retailer. In various embodiments, the system is configured to cause a mobile or other computing device associated with a user associated with the first retailer to display the user interface on a display screen associated with the computing device. In various embodiments, the user interface may be embodied as a software application installed on the computing device. In other embodiments, the system may provide the user interface via a web-based application or in any other suitable manner. In particular embodiments, the system is configured to receive, via the user interface one or more business rules relating to an online marketing campaign (e.g., an online marketing campaign for a particular product). In particular embodiments, the system is configured to receive the one or more business rules at an online marketing campaign server over the Internet. In response to the use providing the one or more business rules, the system may store the one or more business rules in memory.

In various embodiments, the one or more business rules may include one or more business rules relating to one or more requests from the first retailer to make particular adjustments to the online marketing campaign based at least in part on particular conditions. For example, the system may receive one or more business rules relating to: (1) a request to increase one or more bids on one or more keywords related to a particular product in response to determining that a position of the first advertisement for the particular product is relatively low (e.g., not relatively desirable) while the price of the particular product from the first retailer is lower than from one or more retailers that have an advertisement that is in a higher position on a search engine results page or an online marketplace; or (2) a request to decrease one or more bids on one or more keywords related to a particular product in response to determining that a position of the first advertisement for the particular product is relatively high (e.g., first or second, or in a relatively desirable position) while the price of the particular product from the first retailer is higher than from one or more retailers that have an advertisement that is in a lower position on a search engine results page or an online marketplace.

In still other embodiments, the one or more business rules may include, for example: (1) a business rule to cease an online marketing campaign for a particular product for which the first retailer is not offering the product at the lowest price (e.g., the lowest price of the one or more retailers offering the particular product for sale via a particular search engine results page or online marketplace); (2) a business rule to increase a bid on a keyword for which the first retailer is competitive on price but for which an advertisement from the first retailer in not in the most desirable (e.g., most prominent) position on a search engine results page or online marketplace (e.g., a retailer may be competitive on price where their price for the particular product is within a certain threshold of one or more competitor's offered prices such as within a particular percentage such as 5%, 10%, between 0% and 10%, etc.); (3) a business rule to decrease a bid on a particular keyword for which a conversion rate (e.g., a rate at which clicks on an advertisement result in a sale or a rate at which a particular advertisements for a particular product or service result in a sale of the particular product or service) is below a particular rate (e.g., even if the particular product is competitively priced); (4) or any other suitable business rule related to pricing, position, etc. of a particular advertisement or a particular marketing campaign for a particular product.

In various other embodiments, the one or more business rules may include one or more rules in addition to one or more rules related to adjusting one or more bids in response to certain criteria being met. For example, the one or more business rules may include a business rule to decrease (e.g., automatically decrease) a price to within a particular percentage of one or more competitor prices in response to determining that a first advertisement from the first retailer for the particular product is placed desirably on the search engine results page, but the price of the first product from the first retailer is higher than one or more other advertisements on the search engine results page.

In particular embodiments, the system is configured to optimize the position of the first advertisement in relation to one or more other advertisements based at least in part on one or more considerations relating to a price of the first product offered for sale by the particular retailer with respect to the one or more competing retailers. For example, while it may be generally beneficial for the first retailer's advertisement to be positioned first in a search engine results page, the advertisement may not result in many clicks (e.g., or converted sales following clicks) by search engine users if an advertisement in the second position lists the product for a lower price. For example, on a search engine results page for “55 inch Samsung television,” if a Walmart.com advertisement for the product is listed first for $499 and a Bestbuy.com advertisement is listed second for $479, users of the search engine seeking the televisions may be more likely to complete a purchase from Bestbuy.com. In this example, Amazon.com may be wasting money on their online marketing campaign when users click on their ad but instead choose to purchase from Bestbuy.com. If Amazon.com is unable to offer the television at a lower price, it may be beneficial for Amazon.com to reduce a bid on one or more associated keywords and to focus their advertising budget on other products on which they are more competitive in pricing.

In various embodiments, the system is further configured to adjust an online marketing campaign for a particular product based at least in part on an overall marketing budget for a plurality of products offered for sale by the first retailer. For example, the system may determine that one or more bids for one or more keywords associated with a first product offered for sale by the first retailer are too high. The system may further determine that one or more bids for one or more keywords associated with a second product offered for sale by the second retailer are too low. In particular embodiments, the system may, for example, adjust the one or more bids on the first product (e.g., by lowering the one more bids) and the one or more bids on the second product (e.g., by raising the one or more bids) relative to one another such that a resulting marketing spend may be substantially similar to a marketing spend prior to the adjustment. In various embodiments, this may enable a retailer to predict and control an overall marketing cost for various products for which it is advertising. In particular embodiments, such an allocation of marketing dollars may result in higher conversions through search engine advertising (e.g., higher sales), without increasing an overall cost of marketing (e.g., by allocating more marketing dollars to products that are competitively priced and not wasting advertising dollars on products that are priced higher than competitors which may result in relatively fewer sales).

In various embodiments, the system is configured to receive online marketing campaign data for a plurality of products offered for sale for a particular online retailer. The system may be further configured to receive marketing budget information associated with the first retailer. In various embodiments, in response to determining to decrease a first bid on a first keyword for a marketing campaign associated with a first product, the system may be configured to determine at least one second product for which an increase to a second bid on a second keyword may be desirable (e.g., based on any suitable factor discussed herein). The system may them be configured to reallocate one or more funds earmarked to pay for clicks from the lowered first bid to the second bid. For example, the system may proportionally increase the second bid based on estimated savings from having decreased the first bid.

### Illustrative Example

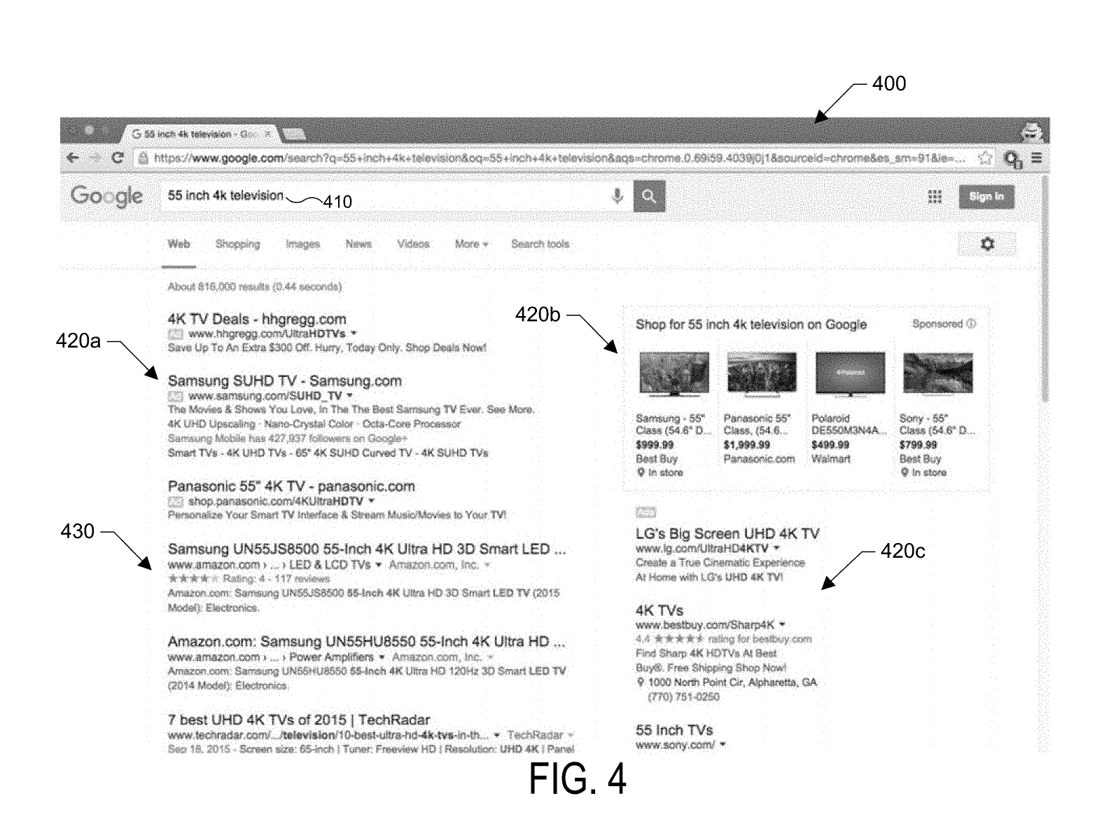

FIG. 4 depicts an exemplary search engine results page 400 resulting from a search query 410 for the term “55 inch 4k television.” In this example, a user of the search engine may be shopping for a television that is 55 inches in size and has “4k” resolution. As may be understood from FIG. 4, the search engine results page 400 includes both advertised results 420a, 420b, 420c and organic results 430.

Particularly savvy shoppers may, for example, investigate (e.g., click on) multiple links to view particular retailer web pages in order to ascertain the best price before making a purchase decision. As may be understood by one skilled in the art, clicks on advertised search results may cost the advertiser (e.g., the particular retailer) money due to pay-per-click advertising. Accordingly, if a retailer's listing is high on the search engine results page 400, but does not include a competitive price for the product, the retailer may end up paying for the click without converting the sale.

In various alternative embodiments, the system may be configured to access links on the search engine results page 400 from the organic search results 430 in order to determine product pricing at the links. The system may, for example, access one or more links that make up part of the organic search results 430; and determine based at least in part on the accessed one or more links, a price for the particular product available at each of the one or more links. The system may be further configured to modify or adjust an online marketing campaign based at least in part on pricing data derived from these organic results 430. In particular embodiments, adjusting an online marketing campaign based on organic search results (e.g., or both organic and paid search results) may enable a particular retailer to save money on online marketing by avoiding paying for a click on one of the particular retailer's advertisements in a search engine results page where at least one of the links (e.g., either the organic search results 430 or the advertised results 420) enable a user of the search engine to purchase the particular product at a price lower than the price offered by the particular retailer.

As may be understood from FIG. 4, advertised search results 420b (e.g., shopping results) vary in price. For example, Panasonic may utilize the system described herein in various embodiments, which may, for example, reduce a bid associated with one or more of the “55 inch 4k television” search terms because the listed price for such a Panasonic television is $1,999 while competitors list the price for $999.99 (Samsung), $499.99 (Polaroid, and $799.99 (Sony).

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method for dynamically adjusting one or more keyword bids for an online marketing campaign for a first product offered for sale by a first advertiser, the method comprising:
receiving, by one or more processors, first pricing data associated with the first product offered for sale by the first advertiser;
receiving, by one or more processors, online marketing campaign data for the first product, the online marketing campaign data comprising:
a first keyword associated with the online marketing campaign; and
a first bid associated with the first keyword;
determining, by one or more processors based at least in part on the first keyword, a position of a first advertisement for the first product relative to one or more other advertisements for the first product associated with one or more competing advertisers on a search engine results page;
determining, by one or more processors, second pricing data associated with the one or more other advertisements; and
substantially automatically adjusting the first bid, by one or more processors, based at least in part on the first pricing data, the second pricing data, and the position of the first advertisement for the first product relative to the one or more other advertisements.

2. The computer-implemented method of claim 1, further comprising:
providing, by one or more processors, a user interface for providing one or more marketing campaign business rules;
causing, by one or more processors, a mobile computing device associated with a user associated with the first advertiser to display the user interface on a display associated with the mobile computing device;
receiving, from the user, by one or more processors, the one or more marketing campaign adjustment preferences; and
storing, by one or more processors, the one or more marketing campaign business rules in memory.

3. The computer-implemented method of claim 2, further comprising:
determining, by one or more processors, based at least in part on the first pricing data and the second pricing data, whether the position of the first advertisement for the first product relative to the one or more other advertisements satisfies the one or more marketing campaign business rules; and
at least partially in response to determining that the position of the first advertisement for the first product relative to the one or more other advertisements does not satisfy the one or more marketing campaign business rules, substantially automatically adjusting the first bid, by one or more processors, based at least in part on the one or more marketing campaign business rules.

4. The computer-implemented method of claim 3, wherein:
substantially automatically adjusting the first bid based at least in part on the one or more marketing campaign business rules comprises transmitting, by one or more processors, a request to adjust the first bid to a third party keyword bidding server over the Internet.

5. The computer-implemented method of claim 4, further comprising:
determining, by one or more processors, third pricing data for the first product from one or more organic search results on the search engine results page;
comparing, by one or more processors, the first pricing data with the third pricing data to determine whether the first pricing data satisfies the one or more marketing campaign business rules; and
in response to determining that the first pricing data does not satisfy the one or more marketing campaign business rules, substantially automatically adjusting the first bid, by one or more processors, based at least in part on the first pricing data, second pricing data, and the position of the first advertisement for the first product relative to the one or more other advertisements.

6. The computer-implemented method of claim 5, wherein the one or more marketing campaign business rules comprise an instruction to increase the first bid in response to determining that the first pricing data comprises a price that is lower than the second and third pricing data and the position of the first advertisement is less desirable than the one or more other advertisements.

7. The computer-implemented method of claim 6, further comprising:
determining, by one or more processors, whether the first pricing data comprises a price that is lower than the second pricing data and the third pricing data;
determining by one or more processors, whether the position of the first advertisement is less desirable than the one or more other advertisements; and
in response to determining that the first pricing data comprises a price that is lower than the second and third pricing data and the position of the first advertisement is less desirable than the one or more other advertisements, substantially automatically transmitting a request to the third party keyword bidding server to increase the first bid.

8. The computer-implemented method of claim 5, wherein the one or more marketing campaign business rules comprise an instruction to cancel the first bid in response to determining that the first pricing data comprises a price that is higher than a price associated with the second pricing data or the third pricing data.

9. A computer-implemented method of automatically adjusting an online marketing campaign for a particular product, the method comprising:
providing a user interface for inputting one or more business rules associated with an online marketing campaign associated with the particular product on a computing device associated with a first retailer;
receiving one or more business rules associated with the online marketing campaign at a marketing campaign server via the user interface over the Internet, the online marketing campaign server comprising one or more processors and a memory that stores online marketing campaign data and pricing data associated with the particular product, wherein:
the online marketing campaign data comprises one or more keywords and one or more bids associated with each of the one or more keywords; and
the pricing data comprises a price at which the particular product is offered for sale by the first retailer;
determining, by one or more processors, a position of a first advertisement for the particular product on a search engine results page derived from an Internet search comprising the one or more keywords;
determining, by one or more processors, second pricing data for a second advertisement for the particular product on the search engine results page; and
substantially automatically adjusting the one or more bids based at least in part on the position of the first advertisement, the pricing data, the second pricing data, and the one or more business rules.

10. The computer-implemented method of claim 9, wherein the method further comprises:
substantially continuously determining, by one or more processors, a substantially current position of the first advertisement for the particular product on the search engine results page derived from the Internet search comprising the one or more keywords; and
substantially continuously adjusting the one or more bids based at least in part on the substantially current position of the first advertisement, the pricing data, the second pricing data, and the one or more business rules.

11. The computer-implemented method of claim 9, wherein the method further comprises:
determining, by one or more processors, a position of the second advertisement on the search engine results page;
determining, by the one or more processors, whether the positon of the first advertisement is more desirable than the position of the second advertisement;
determining, by one or more processors, whether the pricing data is greater than the second pricing data; and
in response to determining that the pricing data is greater than the second pricing data and that the position of the first advertisement is more desirable than the position of the second advertisement, reducing the one or more bids on the one or more keywords by causing the online marketing campaign server to transmit a request via the Internet to a third-party keyword bidding server to reduce the one or more bids based at least in part on the one or more business rules.

12. The computer-implemented method of claim 11, wherein:
determining, by one or more processors, whether the pricing data is greater than the second pricing data comprises determining whether the pricing data is within a particular price of the second pricing data;
the one or more business rules comprise a pricing tolerance; and
the method further comprises determining, by one or more processors, the particular priced based at least in part on the pricing tolerance.

13. The computer-implemented method of claim 11, wherein:
the one or more business rules comprise a request to increase a bid on a keyword associated with an online marketing campaign for a particular product in response to determining that that particular product is priced lower than a price for the particular product offered for sale by one or more competitors advertising the particular product; and
the method further comprises, in response to determining that the pricing data is less than the second pricing data and that the position of the first advertisement is not more desirable than the position of the second advertisement, increasing the one or more bids on the one or more keywords by causing the online marketing campaign server to transmit a request via the Internet to a third-party keyword bidding server to increase the one or more bids based at least in part on the one or more business rules.

14. The computer-implemented method of claim 11, wherein:
the one or more business rules comprise:
a first rule to increase visibility of an advertisement for a product that is priced by the first retailer at a lower than a price offered by one or more competitors, wherein increasing visibility of the advertisement comprises increasing marketing spending on the product; and
a second rule to decrease marketing spending on the product if the product is prices by the first retailer at a higher price than the price offered by the one or more competitors.

15. A computer system for adjusting a marketing campaign for a first product based at least in part on one or more marketing adjustment preferences comprising:
an online marketing campaign server comprising one or more processors and a memory that stores the one or more marketing adjustment preferences, wherein the one or more processors are configured for:
providing, on a computing device associated with a first retailer, a user interface for providing the one or more marketing adjustment preferences;
receiving, via the user interface, the one or more marketing adjustment preferences, wherein the one or more marketing adjustment preferences comprise a request to take a particular action based at least in part on a position and a price of a first advertisement for the first product offered by the retailer relative to one or more second advertisements for the first product offered by one or more second retailers on a search engine results page;
storing the one or more marketing adjustment preferences in memory;
receiving, via a third party keyword bidding server, marketing campaign data associated with the first product for an online marketing campaign initiated by the first retailer the marketing campaign data comprising a first keyword and a first bid associated with the keyword;
submitting a search engine query comprising the keyword, via the Internet, to a search engine associated with the online marketing campaign;
in response to submitting the search engine query, receiving a search engine results page;
determining a relative position of the first advertisement for the first product from the first retailer with respect to the one or more second advertisements for the first product from the one or more second retailers on the search engine results page;
determining a relative price of the first product from the first retailer versus the one or more second retailers;
determining, based at least part on the one or more marketing adjustment preferences, whether to adjust the first bid based at least in part on the relative position of the first advertisement with respect to the one or more second advertisements, and the relative price of the first product from the first retailer versus the one or more second retailers; and
in response to determining to adjust the first bid, transmitting a request to the third party keyword bidding server to adjust the first bid based at least in part on the one or more marketing adjustment preferences.

16. The computer system of claim 15, wherein:
the one or more marketing adjustment preferences comprise a preference for the first advertisement to be a top advertisement on the search engine results page when the price of the first product from the first retailer is lower than the price of the first product from the one or more second retailers.

17. The computer system of claim 16, wherein:
the one or more marketing adjustment preferences comprise a preference for ceasing the marketing campaign for the first product when the price of the first product from the first retailer is higher than the price of the first product from the one or more second retailers.

18. The computer system of claim 17, wherein the one or more processors are further configured for:
determining a price charged for the first product at one or more organic search results on the search engine results page;
determining a relative price of the first product from the first retailer versus the price charged for the first product at the one or more organic search results on the search engine results page;
determining, based at least part on the one or more marketing adjustment preferences, whether to adjust the first bid based at least on the relative price of the first product from the first retailer versus the price charged for the first product at the one or more organic search results on the search engine results page.

19. The computer system of claim 15, wherein:
the one or more marketing adjustment preferences comprise a request to decrease the first bid in response to determining that the first advertisement is positioned in a relatively good position with respect to the one or more second advertisements and the relative price of the first product is higher from the first retailer versus the one or more second retailers;
the one or more processors are further configured for determining whether the first advertisement is positioned in the relatively good position with respect to the one or more second advertisements and the relative price of the first product is higher from the first retailer versus the one or more second retailers; and
in response to determining that the first advertisement is positioned in the relatively good position with respect to the one or more second advertisements and the relative price of the first product is higher from the first retailer versus the one or more second retailers, transmitting the request to the third party keyword bidding server to adjust the first bid, wherein the request to adjust the first bid comprises a request to decrease the first bid by a first amount based at least in part on the one or more marketing adjustment preferences.

20. The computer system of claim 19, further comprising:
receiving online marketing campaign budget information associated with the first retailer;
receiving, via the third party keyword bidding server, other marketing campaign data associated with the one or more other products offered for sale by the first retailer, the other marketing campaign data comprising at least one bid and at least one keyword for each of the one or more other products;
for each of the one or more other products, submitting one or more search engine queries comprising the at least one keyword, via the Internet, to a search engine associated with the online marketing campaign;
in response to submitting the one or more search engine queries, receiving a search engine results page for each of the one or more other products;
determining a relative position of an advertisement for each of the one or more other products from the first retailer with respect to one or more competing advertisements for each of the one or more other products from the one or more competing retailers on each of the search engine results pages;
determining a relative price of each of the one or more other products from the first retailer versus the one or more competing retailers;
determining, based at least part on the one or more marketing adjustment preferences, whether to increase the at least one bid for at least one of the one or more other products based at least in part on the relative price of the at least one of the one or more other products from the first retailer versus the one or more competing retailers and the relative position of the advertisement for the at least one of the one or more other products from the first retailer with respect to the one or more competing advertisements for the at least one of the one or more other products from the one or more competing retailers; and
in response to determining: (1) that the first advertisement is positioned in the relatively good position with respect to the one or more second advertisements and the relative price of the first product is higher from the first retailer versus the one or more second retailers; and (2) to increase the at least one bid for the at least one of the one or more other products: transmitting a request to the third party keyword bidding server to increase the at least one bid for the at least one of the one or more other products by a second amount based at least in part on the first amount and the online marketing campaign budget information.
